(19) United States
(12) Patent Application Publication
(10) Pub. No.: US 2006/0245343 A1
(43) Pub. Date: Nov. 2, 2006

(54) Dummy links in storage medium content

(75) Inventors: Bei Wang, Shanghai (CN); Thomas Boltze, Shanghai (CN); Declan Patrick Kelly, Shanghai (CN); Baoxiong Wang, Shanghai (CN); Sheng Kim, Shanghai (CN); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKIJKLE ELECTRONICS N.V.

(21) Appl. No.: 10/570,292

(22) PCT Filed: Aug. 19, 2004
(86) PCT No.: PCT/IB04/51492

§ 371 Date: Feb. 28, 2006

(51) Int. Cl. G11B 7/24

(52) U.S. Cl. 369/275.3

(57) ABSTRACT

A rewritable storage medium comprising predefined content which is adapted for being integrated with additional user-defined content is described, the storage medium comprises: a first portion comprising said predefined content; a second portion for adding said user-defined content; wherein said predefined content in said first portion comprises links to said second portion. Thereby the user can customise the predefined content on the storage medium by adding personal content being an integrated part of the predefined content. Further the user can make dedicated annotations and comments on each category he visits, the connection is built up by the dummy links. According to the invention the user's own content is integrated with the published part of the disc giving an easily personalised guide book. In more general terms the user buys disc content with some prepredefined content, which can be enhanced by user's own content in a seamless way.

The present invention relates to a rewritable storage medium comprising predefined content which is adapted for being integrated with additional user-defined content. The invention further relates to an apparatus for handling a rewriteable storage medium.

Storage mediums can be used for a wide variety of applications and today a number of different types of storage mediums exist on the market: DVD, CD, memory cards, etc.

SFFO (Small Form Factor Optical Disc) also called Portable Blue Disc is characterized as a portable, high storage capacity and low cost format. One of the applications for which SFFO is used is as a disc ticket e.g. for entering a theme park or a museum.

In general the increasing use of various types of storage mediums has created a need for it to be able to integrate pre-generated pre-stored storage medium read-only content with user-defined content.

U.S. 2002/0140988 describes a PC environment, where specific parts of the photo on a display can be linked to specific content. Thereby, when the specific content is selected, the related content is presented to the user. Here the links are generated by linking display areas with user-defined content; it is not described how one can integrate user-defined software to read-only content. Further the content can include only images.

It is an object of the present invention to provide a solution to the above-mentioned problems.

This is achieved by providing a rewritable storage medium comprising predefined content which is adapted for being integrated with additional user-defined content, the storage medium comprising:
a first portion comprising said predefined content;
a second portion for adding said user-defined content;
wherein said predefined content in said first portion comprises links to said second portion.

Thereby the user can customise the predefined content on the storage medium by adding personal content that is an integrated part of the predefined content. Further the user can make dedicated annotations and comments on each category he visits, such as each landscape he visits in the theme park, each stand he visits in the museum, etc, and the connection is built up by the dummy links. The user can also store photos taken in various locations and link them to the corresponding predefined content category. Further the user can download extra information about the park or the museum and link them to the corresponding content categories. For other people who are interested in the predefined content only and not the user's personal content, they can just ignore the links and go through the predefined content very quickly. It is easier to protect the user's personal content if the content is stored in this way. According to the invention the user's own content is seamlessly integrated with the published part of the disc, giving an easily personalised guide book. In more general terms the user buys (downloads) disc content with some pre-predefined content, which can later be enhanced by the user's own content in a seamless way.

In a specific embodiment said second portion comprises replaceable predefined dummy content, wherein said predefined content in said first portion comprises links to the predefined dummy content. Thereby the dummy content can be used to promote content that the user can download at the theme park/museum etc.

In a specific embodiment the rewriteable storage medium is a user specific ticket for a tourist attraction and wherein the predefined content comprised in said first portion comprises tourist-attraction specific information. This is a very smart way of adding value to the visit of the tourist attraction and makes it possible to incorporate a presentation of the attraction with user specific content, such as own pictures, sound, notes etc.

In a specific embodiment the storage medium is a SFFO (Small Form Factor Optical Disk). The disk is also referred to as a Portable Blue Disk being a disk having room for large amounts of content and therefore ideal for adding high-level multimedia content, such as video.

In a specific embodiment the storage medium is a hybrid disk comprising a ROM portion and a RW portion, respectively, wherein the first portion comprising said predefined content is the ROM portion and wherein the second portion for adding said user-defined content is the RW portion. Thereby it is the user-defined content only that can be deleted and it is not possible to accidentally delete the predefined content.

In a specific embodiment the second portion of the storage medium further comprises a redirection table and wherein the link between the predefined content to said second portion comprises a first link from the predefined content in said first portion to the redirection table and a second link from the redirection table to said second portion. By having this re-direction table for providing the link between the predefined content and the user-defined content, it is not necessary that the predefined knowledge knows the positions of the user-defined content. Instead it should only comprise a link to the re-direction table. This redirection table is then updated when user-defined content is added and thereby the re-direction table can be used to locate the user-defined content, when the content is requested via the predefined content.

In an embodiment the predefined content in said first portion is XML files and wherein the links between said predefined content in said first portion to said second portion are URLs embedded in the XML files. This is an easy and fast way of generating the content.

The invention further relates to an apparatus for handling a rewriteable storage medium according to the invention, wherein the apparatus comprises:
means for reading the predefined content stored in the first portion of the medium;
means for presenting the predefined content to a user;
means for receiving input from a user;
means for receiving user-defined data;
means for storing the user-defined data in said second portion of the medium.

The apparatus could e.g. be a PDA, a mobile phone, a dedicated device positioned in connection with e.g. a museum or an attraction in an amusement park.

In the following preferred embodiments of the invention will be described referring to the figures, where

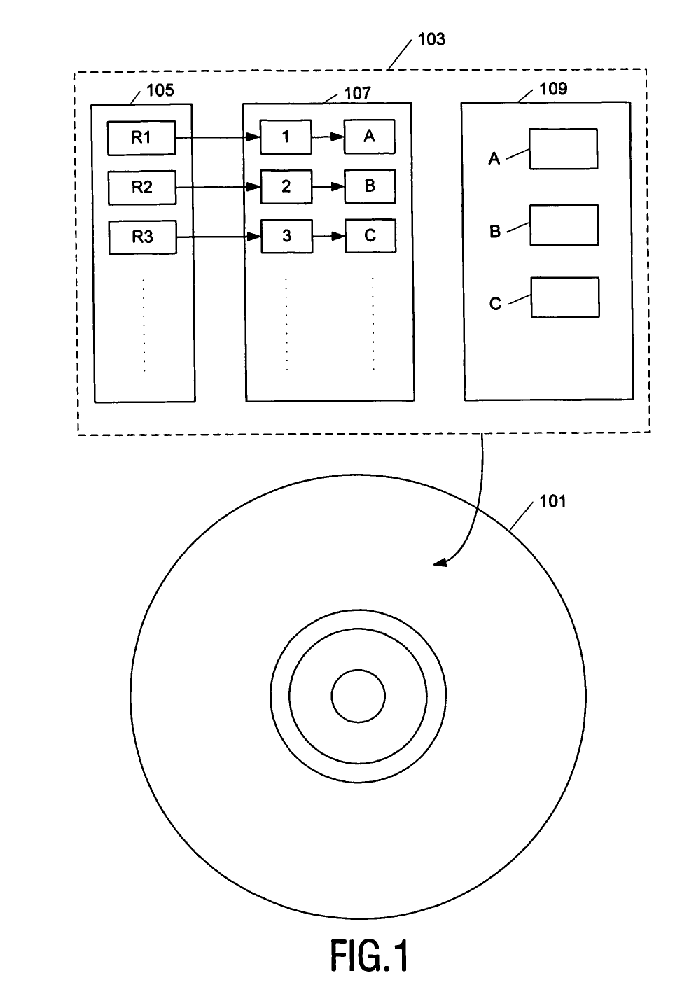

FIG. 1 illustrates storage medium comprising content according to the present invention;

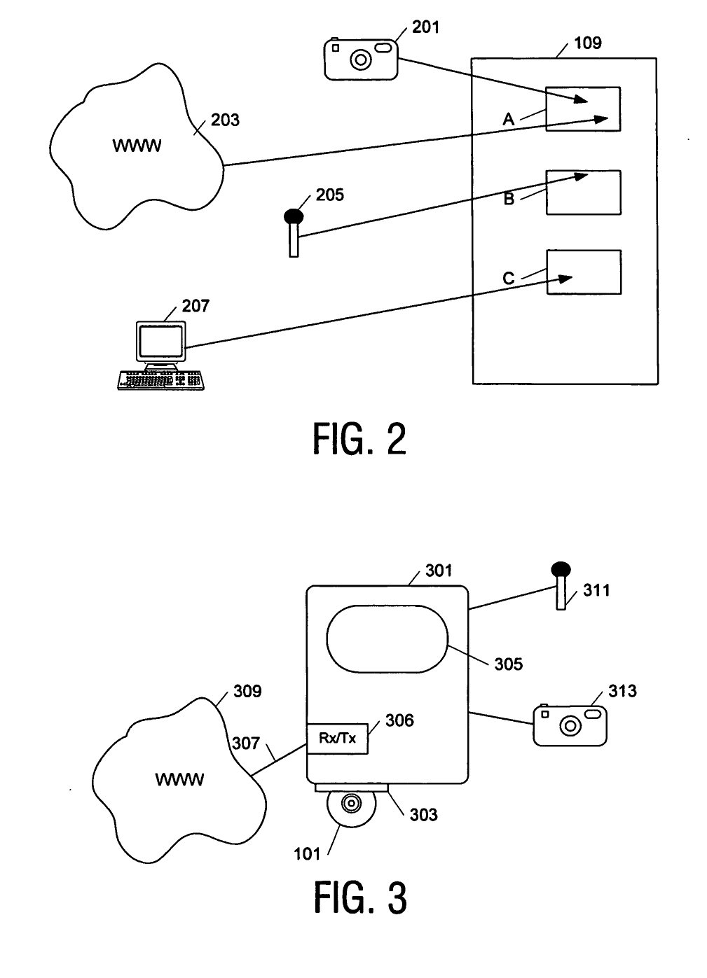

FIG. 2 illustrates an example of different types of user-defined content or data being stored on the rewriteable second portion of the storage medium;

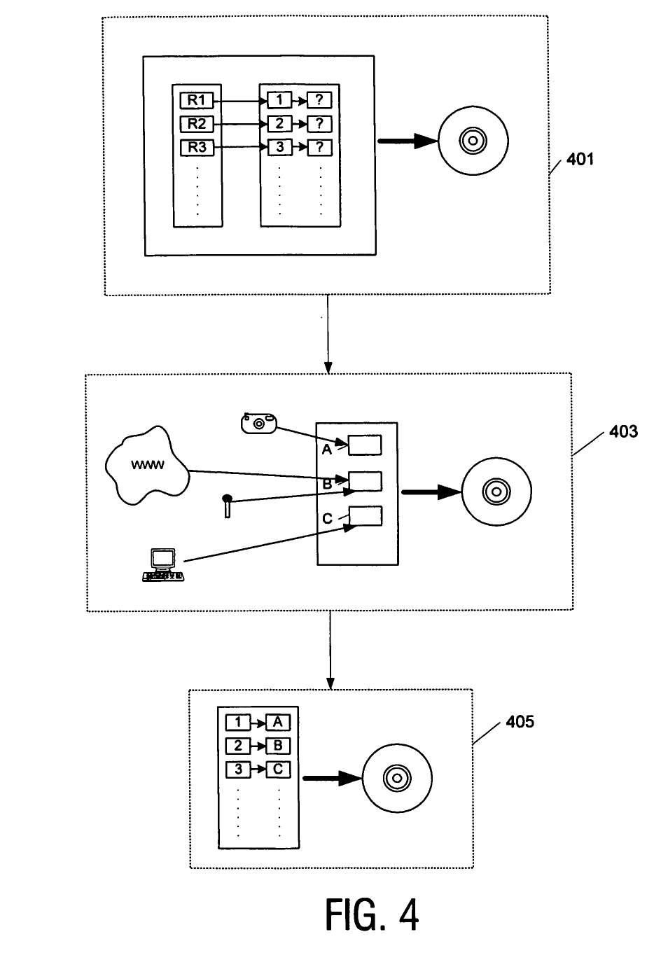

FIG. 3 illustrates an apparatus for handling a disk with content according to the present invention;

FIG. 4 illustrates the process of adding predefined content in the first portion of the storage medium and user-defined content in said second portion of said storage medium, respectively.

In FIG. 1 a storage medium 101 is illustrated that comprises content 103 according to the present invention. The content consists of a first portion 105 comprising predefined content, which is not supposed to be changed. The predefined content comprises links R1, R2, R3 to a redirection table 107 and further the content 103 comprises a second portion 109 for adding user-defined content. The redirection table then provides a link between the first portion 105 and the second portion 109 being illustrated as the arrows 1->A, 2->B and 3->C. The links in the predefined content points to 1, 2 and 3, which then points further to the areas A, B and C in the second portion of the storage medium. By using a storage medium comprising content 103 as described above it is possible to add personal content to a disc, which then can be an integrated part of the predefined content stored in the first portion of the storage medium. This is possible because of the links in the re-direction table.

In a specific example it could be storage mediums such as a SFFO disc, being used as a disc ticket. Visitors to a theme park or museum use such a disc ticket as pass. On the ticket, the visitors can find park- or museum-related predefined content, e.g. in the form of an interactive guide. The predefined content can be in the form of video, audio or text. Usually the predefined content is authored beforehand and can be stored either on the disc 101 or be downloaded to the disc via the park/museum website. The predefined content, which the user does not change, should be either logically or physically read-only.

As mentioned above the visitor can obtain the predefined content in two ways:
1. The visitor accesses the park/museum website, pays through the web and downloads the predefined content on his own disc 101.
2. The visitor buys a disc 101 at the entrance and the predefined content is already loaded on the disc.

The disc could be either a hybrid disc or a RW disc. A hybrid disc is a disc that comprises read only as well as read/write data storage areas. The predefined content in the first portion 105 of the disc potentially occupies only a small part of the disc space.

The second portion 109 of the disc space can be used to store the visitor's own user-defined content. For example, the visitor stores his photos taken in a particular area in the park and integrates them with the predefined content. The visitor can add his notes or annotations to a particular exhibit in the museum. The common feature of these added contents is that they will be linked to the predefined content. To enable this, dummy links have been added to the predefined content during the content authoring pointing to the redirection table 107. This enables the visitor to extend these links to the corresponding user-defined content. Once the visitor finishes his trip and starts to read the predefined content, he can click on those built-in dummy links to direct him to his own user-defined content. E.g. the description of a roller coaster could have a link set-up with the title “Your picture in the middle of the looping”. Before the ride is taken and the picture is filled in, this link does not lead anywhere, but after the picture (or any other picture at the visitor's discretion) is stored on the disc, the link can be completed. The links are set up during the content authoring stage. The links are embedded in the predefined content of a disc, but through one step of indirection they can be made to point anywhere a URL can point to. All links points to the redirection table 107 in the RW space of the disc 101. The redirection table 107 enables links to point to any arbitrary destination that can be described by a URL. It also enables several links in the pre-recorded part to eventually point to the same object. It is further possible that the links point to proxy objects. This allows the user to replace generic pictures of people on a ride in the park by their own pictures.

The predefined content on the disc can be described by XML files and the dummy links are expressed by URLs embedded in the XML files. These URLs all point to the re-direction table 107. The re-direction table 107 is updateable and it enables links to point to any arbitrary destination URLs. It also enables several links in the predefined part to eventually point to the same object. The redirection table can be implemented by an XML or HTML document that provides the redirection functionality.

In FIG. 2 an example of different types of user-defined content or data being stored on the rewriteable second portion of the storage medium is illustrated. This user-defined content can then be linked to the predefined content via the re-direction table. The user-defined content added by the user to the second portion 109 of the storage medium is illustrated as A, B and C. In this example a combination of personal data from a digital camera 201 and the Internet 203 is stored in the area A. In B speech is stored using a microphone 204 and in C data from a personal computer 205 is stored being e.g. text or a pre-stored movie sequence. In general a lot of different types of data could be stored, the only requirement is that a device is used which makes it possible to obtain the data and store the data on the storage medium.

In FIG. 3 an apparatus 301 is illustrated for handling a disk with content 103 according to the present invention. The apparatus could have the following capabilities, but not all are required:
A drive 303 for reading data from the disc 101, writing data to the disc, error detection and correction operations, etc.
A display screen 305 which e.g. could be a touch screen to allow user input.
A receiver/transmitter 306 for establishing a connection 307 to the internet 309, whereby the visitors can access the park/museum website and download content from the web. The web-connectivity of the device could be either wired or wireless. A simple web browser also needs to be provided via the display screen 305 on the device in order to navigate web content.
In order to allow the visitors to add their own content that is linked to appropriate content locations, a simple real-time authoring tool needs to be provided by the device, which e.g. could be via the touch screen 305 or by an externally connected keyboard.
Further the apparatus might also have a video and/or audio 311 recording unit and a camera 313 function.

The device could e.g. be either a dedicated device or combined with other portable devices that can support above functions, such as a PDA, mobile phone, etc.

In FIG. 4 the process of adding respectively predefined content in the first portion 105 of the storage medium and user-defined content in said second portion 109 of said storage medium is illustrated. In 401 the predefined content is placed on the disk, this could e.g. be done via the Internet or it could be pre-stored before the user received the storage medium. When the predefined content initially is stored no user-defined content has been stored on the storage medium and therefore only dummy links are available in the predefined content. Next in 403 the user adds new content to a location, by selecting a dummy link in the existing content. If the link does not lead anywhere yet, the user is asked to provide the content, either by entering it (e.g. notes, audio or an image/video) or by browsing to the location of the content that the user wants this link to lead to. If the link already leads to user-defined content, this can be shown embedded in the original content or as a link that can be traversed. The user can also choose to replace existing content with a new version. Finally in 405 the redirection table is updated to ensure that the predefined content is correctly linked to the added user-defined content.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

In summary, the invention relates to a rewritable storage medium comprising predefined content which is adapted for being integrated with additional user-defined content, the storage medium comprises: a first portion comprising said predefined content; a second portion for adding said user-defined content; wherein said predefined content in said first portion comprises links to said second portion.

Thereby the user can customise the predefined content on the storage medium by adding personal content being an integrated part of the predefined content. Further the user can make dedicated annotations and comments on each category he visits, the connection is built up by the dummy links. It is easier to protect the user's personal content if the content is stored in this way. According to the invention the user's own content is integrated with the published part of the disc giving an easily personalised guide book. In more general terms the user buys disc content with some pre-predefined content, which can be enhanced by user's own content in a seamless way.

1. A rewritable storage medium (101) comprising predefined content which is adapted for being integrated with additional user-defined content (109), the storage medium comprising:
a first portion (105) comprising said predefined content;
a second portion (109) for adding said user-defined content;
wherein said predefined content in said first portion comprises links to said second portion.

2. A rewriteable storage medium according to claim 1, wherein said second portion comprises replaceable predefined dummy content, wherein said predefined content in said first portion comprises links to said predefined dummy content.

3. A rewriteable storage medium according to claim 1, wherein the rewriteable storage medium is a user specific ticket for a tourist attraction and wherein the predefined content comprised in said first portion comprises tourist-attraction specific information.

4. A rewriteable storage medium according to claim 1, wherein the storage medium is a SFFO (Small Form Factor Optical Disk).

5. A rewriteable storage medium according to claim 1, wherein the storage medium is a hybrid disk comprising respectively a ROM portion and a RW portion, wherein the first portion comprising said predefined content is the ROM portion and wherein the second portion for adding said user-defined content is the RW portion.

6. A rewriteable storage medium according to claim 5, wherein the second portion of the storage medium further comprises a redirection table (107) and wherein the link between the predefined content to said second portion comprises a first link from the predefined content in said first portion to the redirection table and a second link from the redirection table to said second portion.

7. A rewriteable storage medium according to claim 1, wherein the predefined content in said first portion is XML files and wherein the links between said predefined content in said first portion to said second portion are URI's embedded in the XML files.

8. An apparatus for handling a rewriteable storage medium according to claim 1, wherein the apparatus comprises:
means (303) for reading the predefined content stored in the first portion of the medium;
means (for presenting the predefined content to a user;
means for receiving input from a user;
means for receiving user-defined data;
means for storing the user-defined data in said second portion of the medium.

9. An apparatus according to claim 8, wherein the apparatus is a portable device.

10. A data signal describing predefined content which is adapted for being integrated with additional user-defined content after having been stored on a storage medium, said predefined content is adapted for being positioned on a first portion of said storage medium and comprises links to a second portion of said storage medium for adding user-defined content.
